(19) United States
(12) Patent Application Publication
(10) Pub. No.: US 2006/0279968 A1
(43) Pub. Date: Dec. 14, 2006

(54) DC/AC converter circuit and DC/AC conversion method

(75) Inventor: Takahide Iida, Kariya-shi (JP)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Kabushiki Kaishi Toyota Jidoshokki, Kariya-shi (JP)

(21) Appl. No.: 11/450,940

(22) Filed: Jun. 8, 2006

(30) Foreign Application Priority Data
Jun. 9, 2005 (JP) 2005-169275

(51) Int. Cl. H02M 3/335

(52) U.S. Cl. 363/21.01

(57) ABSTRACT

A switching circuit 13 switches transistors M1, M2 at a first high frequency f1 (100 kHz). Thereby, a DC low voltage input is converted into an AC voltage having a high frequency of 100 kHz. A transformer TR1 insulation-transfers the AC voltage of 100 kHz outputted from the switching circuit 13. Transistors M7, M8 provided in the secondary side are formed such that the state where the transistor M7 is conductive whereas the transistor M8 is non-conductive and the state where the transistor M7 is non-conductive whereas the transistor M8 is conductive are alternately changed at a second frequency f2 (55 Hz). An AC output filter 15 outputs an AC voltage corresponding to a commercial AC power source of 55 Hz, 100V to supply to a load 14. In conversion from a DC voltage to an AC voltage by use of a transformer, simplified converting operation is employed so that the circuit can be scaled down and use of a small-sized transformer is realized.

### CROSS-REFERENCE TO RELATED APPLICATIONS

This application is based upon and claims the benefit of priority from the prior Japanese Patent Application No. 2005-169276 filed on Jun. 9, 2005, the entirety of which is incorporated herein by reference.

### FIELD OF THE INVENTION

The present invention relates to a DC/AC converter circuit and a DC/AC conversion method. More particularly, the present invention is directed to a DC/AC converter circuit and a DC/AC conversion method which involve a simple circuit configuration due to simple converting operation and realize use of a compact-sized transformer.

### BACKGROUND OF THE INVENTION

FIG. 5 is a block diagram showing the configuration of an AC inverter for use in automobiles disclosed in Japanese Unexamined Patent Publication No. 2002-315351. As shown in FIG. 5, this AC inverter includes a DC input unit 121; a switching circuit 124; a transformer 125; a DC high-voltage rectifying circuit 126 (smoothing circuit); a driving circuit 128 (alternating circuit); an AC output filter 129; an AC output unit 130; a control circuit 133 for driving circuit control; an isolation unit 134; and a control unit 135 including a microcomputer.

The switching circuit 124 is a push-pull circuit for oscillating a DC low-voltage input (DC 12V) at, for instance, 55 kHz. The switching circuit 124 has two FETs 124a, 124b that are connected between the ends of the primary coil of the transformer 125 and GND respectively and a DC/DC switching circuit 124c for controlling the FETs 124a, 124b.

The transformer 125 is a high-voltage coil for producing a high voltage (e.g. DC140V) as an inverter output. Connected to the center of the primary coil is a power supply line 121b (the output side of a DC input filter 123) that is connected to the power supply terminal of the DC input unit 121. The FETs 124a and 124b are connected so as to be symmetrical with respect to the power supply line 121b.

The DC high-voltage rectifying circuit 126 (smoothing circuit) has a common line (not shown) for connection of the central part of the high-voltage coil; a diode (not shown) for irreversibly connecting both ends of the high-voltage coil to a DC output line 126a; and a capacitor (not shown) connected between the DC output line 126a and a common. The DC high-voltage rectifying circuit 126 smoothes the waveform of a high voltage output generated in the high-voltage coil of the transformer 125 by the high-frequency oscillation of the switching circuit 124 to output to the driving circuit 128 through the DC output line 126a.

The driving circuit 128 (alternating circuit) consists of a bridge circuit connected between the DC output line 126a of the DC high-voltage rectifying circuit 126 and the common. The bridge circuit is a single phase inverter circuit for generating an AC voltage of 55 Hz between the two AC output lines 128a and 128b.

The AC output filter 129 is a filter circuit composed of a choke coil and a capacitor that are connected to the AC output lines 128a, 128b. This filter 129 removes a ripple component from the secondary output (AC high-voltage output). The AC output unit 130 is an output unit having a power supply output terminal (not shown) for connecting a load (electric appliance) to the AC output lines 128a , 128b.

As other related techniques, there are known the DC/AC converter circuits disclosed in Japanese Unexamined Patent Publication No. 5-3678 and Japanese Unexamined Utility Model Publication No. 6-9384.

### SUMMARY OF THE INVENTION

In the conventional AC inverter (DC/AC converter circuit), after a DC voltage (DC 12V supplied from the power supply line 121a) is converted into a high-frequency high AC voltage through the transformer 125, the AC voltage is converted into a high DC voltage in the DC high-voltage rectifying circuit 126 and then an AC voltage having a specified frequency is generated in the driving circuit 128. Thus, three converting steps (DC→AC→DC→AC) are required for conversion from a DC voltage to an AC voltage. Such conversion involves a complicated circuit configuration, which brings about problems such as an increased circuit scale, increased costs caused by an increase in the number of parts, and decreased reliability.

Direct conversion from a DC voltage to an AC voltage may be possible if the oscillating frequency of the switching circuit 124 is set to a desired frequency (55 Hz) for the AC output unit 130. However, the reduction of the oscillating frequency gives rise to the necessity of increasing the core size of the transformer 125, which causes the magnetic saturation of the transformer. To avoid this, the DC/AC converter circuit has to be increased in size and therefore this solution is impractical. The risk of the magnetic saturation of the transformer itself is a problem.

In addition, the AC inverter has revealed another drawback that the conversion efficiency decreases owing to a loss attributable to the complicated circuit configuration which includes the FETs 124a, 124b; a diode provided for the DC high-voltage rectifying circuit 126; and an H bridge constituted by four FETs provided for the driving circuit 128.

The present invention is directed to overcoming at least one of the problems presented by the prior art techniques and a primary object of the invention is therefore to provide a DC/AC converter and a DC/AC conversion method which perform simple converting operation when converting a DC voltage into an AC voltage with a transformer, thereby realizing a simplified circuit configuration and which enable use of a compact-sized transformer. p In order to achieve the above object, according to a first aspect of the present invention, a DC/AC converter comprises:

a switching circuit for converting a DC voltage into an AC voltage having a first frequency a transformer for insulation-transferring the AC voltage:

a first rectifying device incorporated into a path that connects terminals of a secondary winding of the transformer;

a second rectifying device incorporated into the path that connects the terminals of the secondary winding of the transformer, so as to have a direction opposite to the direction of the first rectifying device; and

first and second bypass switches for bypassing the first and second rectifying devices respectively,

wherein a state where the first bypass switch is in its conductive state whereas the second bypass switch is in its non-conductive state and a state where the first bypass switch is in its non-conductive state whereas the second bypass switch is in its conductive state are alternately changed at a second frequency that is lower than the first frequency.

A DC voltage is converted into an AC voltage having the first frequency by the switching circuit. The AC voltage is insulation-transferred by the transformer. The first rectifying device is inserted into a path that connects the terminals of the secondary winding of the transformer. The second rectifying device is inserted into the path that connects the terminals of the secondary winding of the transformer and has a direction opposite to the direction of the first rectifying device. The first and second bypass switches are provided so as to bypass the first and second rectifying devices, respectively. The first and second bypass switches are formed such that the state where the first bypass switch is in its conductive state whereas the second bypass switch is in its non-conductive state and the state where the first bypass switch is in its non-conductive state whereas the second bypass switch is in its conductive state are alternately changed at the second frequency that is lower than the first frequency. The second frequency is the frequency of the AC voltage outputted from the DC/AC converter and a target frequency to be obtained. For instance, if the purpose of use of the converter is providing a general type commercial power supply, the second frequency is 55 (Hz).

When the first rectifying device is bypassed by the first bypass switch, a current path corresponding to the forward direction of the second rectifying device is formed in the secondary side of the transformer. Accordingly,. a voltage component having a polarity that generates an electric current flowing in the forward direction of the second rectifying device is selected by this current path from AC voltages generated in the secondary winding of the transformer. Similarly, when the second rectifying device is bypassed by the second bypass switch, a current path corresponding to the forward direction of the first rectifying device is formed in the secondary side of the transformer. Accordingly, a voltage component having a polarity that generates an electric current flowing in the forward direction of the first rectifying device is selected by the current path from AC voltages generated in the secondary winding of the transformer.

Since the state where the first bypass switch is in its conductive state whereas the second bypass switch is in its non-conductive state and the state where the first bypass switch is in its non-conductive state whereas the second bypass switch is in its conductive state are alternately changed at the second frequency, the polarity of the voltage outputted from the secondary side of the transformer is changed at the second frequency. As a result, an AC voltage having the first frequency can be directly converted into an AC voltage having the second frequency.

With the above arrangement, DC/AC conversion using a transformer can be performed by one converting operation from a DC voltage to an AC voltage. This enables it to simplify the circuit because the number of converting operations can be reduced compared to the circuits that require three converting operations such as DC→AC→DC→AC for a conversion between a DC voltage and an AC voltage. As a result, a scale-down circuit, cost reduction due to a reduced number of parts, and an improvement in the reliability etc. of the DC/AC converter circuit can be achieved.

The switching circuit outputs an AC voltage having the first frequency higher than the second frequency and this AC voltage is transferred by the transformer. Therefore, a higher transfer efficiency can be attained when transferring power with the transformer, compared to the case of power transfer at the second frequency. In consequence, use of a compact-sized transformer can be realized and the magnetic saturation of the transformer can be prevented.

According to a second aspect of the invention, a DC/AC conversion method comprises the steps of:

converting a DC voltage into an AC voltage having a first frequency;

transferring the AC voltage having the first frequency to a secondary side through a transformer; and

converting the AC voltage having the first frequency that appears in a secondary winding of the transformer into an AC voltage having a second frequency that is lower than the first frequency.

In the DC/AC voltage conversion step, a DC voltage is converted into an AC voltage having the first frequency. The AC voltage having the first frequency is transferred to the secondary side of the transformer so that the AC voltage having the first frequency is generated in the secondary winding of the transformer. Then, the AC voltage having the first frequency is directly converted into an AC voltage having the second frequency that is the target frequency.

Thereby, DC/AC conversion using a transformer can be made through one converting operation from a DC voltage to an AC voltage. Such conversion involves a less number of converting operations, compared to circuits that require a plurality of converting operations for converting a DC voltage into an AC voltage, so that the circuit can be simplified. As a result, the circuit can be scaled down and cost reduction due to a reduction in the number of parts can be accomplished.

The above and further objects and novel features of the invention will more fully appear from the following detailed description when the same is read in connection with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a circuit diagram of a DC/AC converter 10 according to a first embodiment of the invention.

FIG. 2 is a timing chart (No. 1) of the DC/AC converter 10.

FIG. 3 is another timing chart (No. 2) of the DC/AC converter 10.

FIG. 4 is a circuit diagram of a DC/AC converter 10a according to a second embodiment.

FIG. 5 is a block diagram illustrating the configuration of the AC inverter disclosed in Japanese Unexamined Patent Publication No. 2002-315351.

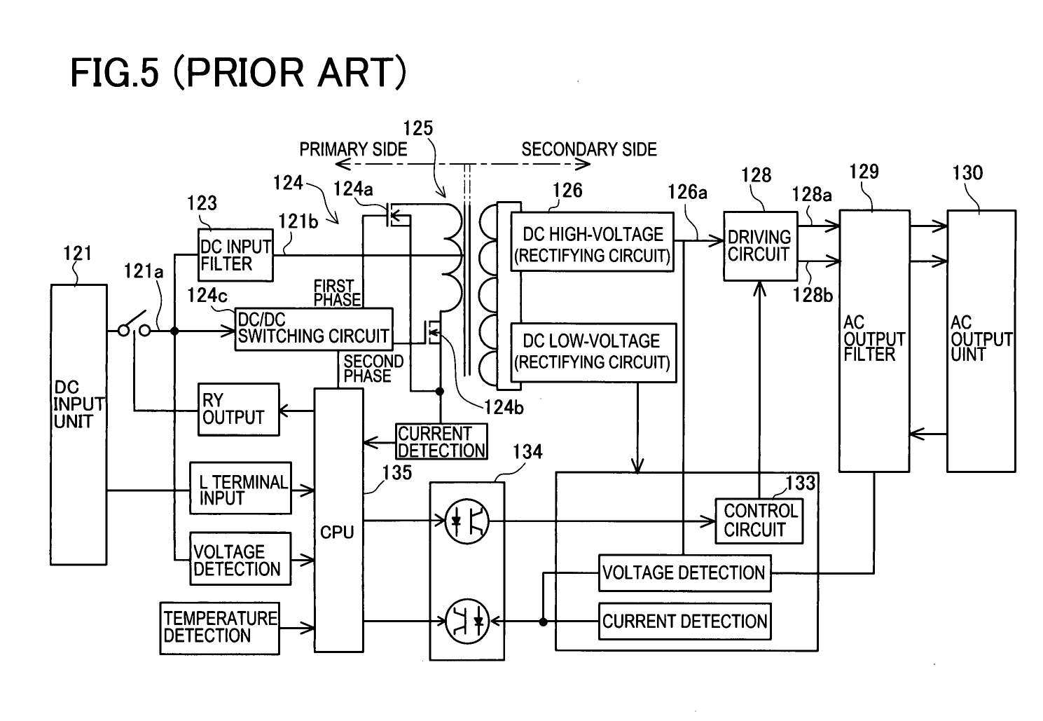

FIG. 6 is a circuit diagram of a conventional DC/AC converter 200.

FIG. 7 is a timing chart of the conventional DC/AC converter 200.

### DETAILED DESCRIPTION OF ILLUSTRATIVE EMBODIMENTS

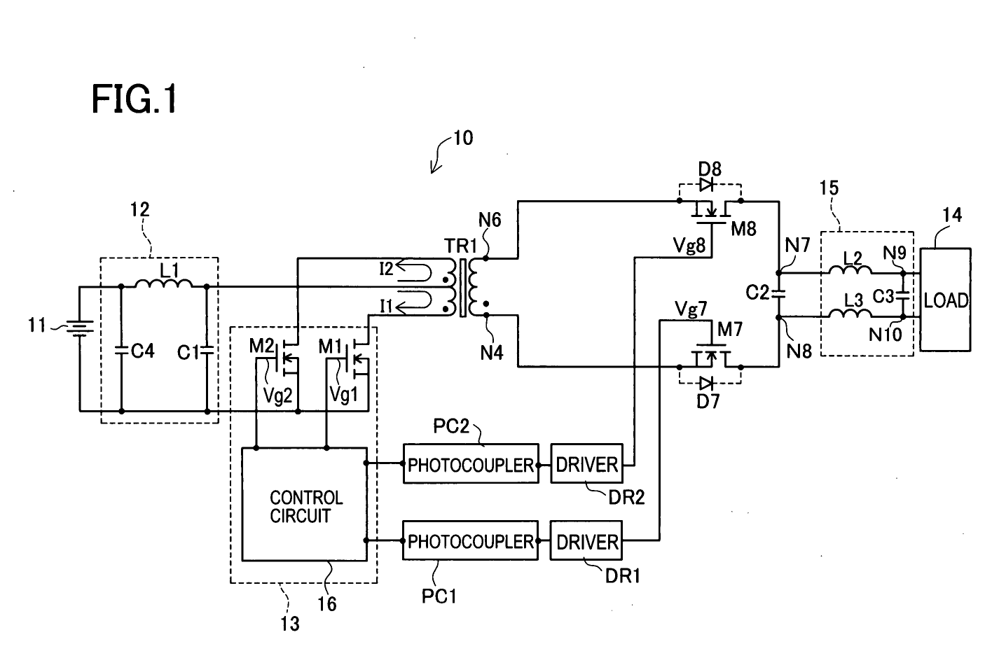

Referring now to FIGS. 1 to 4, the DC/AC converter of the invention will be hereinafter described in detail according to preferred embodiments. A first embodiment is shown in FIGS. 1 to 3. FIG. 1 is a circuit diagram of a DC/AC converter 10 constructed according to the first embodiment. The DC/AC converter 10 has a DC power supply 11; a DC input filter 12; a switching circuit 13; a transformer TR1; transistors M7, M8; a smoothing capacitor C2; an AC output filter 15; photocouplers PC1, PC2; and drivers DR1, DR2.

The DC power supply 11 is connected to the transformer TR1 and the switching circuit 13 through the DC input filter 12. As the DC power supply 11, a buttery (DC 12V) for use in vehicles, for instance, may be used. The DC input filer 12 is composed of a coil L1 and capacitors C1, C4. One end of the coil L1 is connected to the positive electrode of the DC power supply 11 whereas the other end being connected to the central tap of the transformer TR1. The capacitor C1 is connected between the terminal of the coil L1 on the side of the transformer TR1 and the negative electrode of the DC power supply 11. The capacitor C4 is connected between the terminal of the coil L1 on the side of the DC power supply 11 and the negative load of the DC power supply 11. The DC input filter 12 operates as a filter circuit to remove a ripple component. The switching circuit 13 includes transistors M1, M2 and a control circuit 16. Either of the outputs of the DC input filter 12 is connected to the central tap of the primary winding of the transformer TR1. The drain terminals of NMOS transistors M1, M2 are connected to the ends, respectively, of the primary winding of the transformer TR1, whereas their source terminals are connected to the other output of the DC input filter 12, so that the transistors M1, M2 are symmetrically arranged with respect to the central tap.

A gate voltage Vg1 is applied to the gate of the transistor M1 from the control circuit 16 and a gate voltage Vg2 is applied to the gate of the transistor M2 from the control circuit 16, so that the switching circuit 13 switches the transistors M1, M2 at a first high frequency f1 (100 kHz). It should be noted that the electric current flowing to the central tap of the transformer TR1, the primary winding and the transistor M1 in this order when the transistor M1 is conductive is referred to as “primary current I1” and that the electric current flowing to the central tap of the transformer TR1, the primary winding and the transistor M2 in this order when the transistor M2 is conductive is referred to as “primary current 12”. With the above arrangement, a DC low voltage input (DC 12V) is converted into an AC Voltage having a high frequency of 100 kHz. The transformer TR1 insulation-transfers an AC voltage of 100 kHz outputted from the switching circuit 13.

The source terminals of NMOS transistors M7, M8 are connected to nodes N4, N6, respectively, in the secondary winding of 5 the transformer TR1. The transistors M7, M8 include body diodes D7, D8, respectively. Each of the body diodes D7, D8 has a rectifying direction from its source terminal to its drain terminal as indicated by dot line in FIG. 1. Therefore, the body diode D7 and the body diode D8 which has a rectifying direction opposite to that of the body diode D7 are inserted into a path that connects the nodes N4 and N6 of the secondary winding, such that the body diodes D7, D8 are parallel to the transistors M7, M8, respectively. More specifically, the body diode D8 is connected in a direction to flow an electric current to the secondary winding of the transformer TR1 when the transistor M1 is conductive and the primary current I1 flows. The body diode D7 is connected in a direction to flow an electric current to the secondary winding of the transformer TR1 when the transistor M2 is conductive and the primary current 12 flows.

A gate voltage Vg7 is outputted from the control circuit 16 through the photocoupler PC1 and the driver DR1 and applied to the gate of the transistor M7. A gate voltage Vg8 is outputted from the control circuit 16 through the photocoupler PC2 and the driver DR2 and applied to the gate of the transistor M8. The drain terminal of the transistor M7 is connected to a node.N8. The drain terminal of the transistor M8 is connected to a node N7. Connected between the nodes N7, N8 is the smoothing capacitor C2. The nodes N7, N8 are connected to the input terminal of the AC output filter 15. The AC output filter 15 is composed of coils L2, L3 and a capacitor C3. One end of the coil L2 is connected to the node N7, whereas the other end is connected to a node N9. One end of the coil L3 is connected to the node N8, whereas the other end is connected to a node N10. Connected between the nodes N9, N10 is the capacitor C3. A load 14 is connected between the nodes N9 and N10. An AC voltage corresponding to a 100V commercial AC power supply having the second frequency f2 (55 Hz) is outputted from the AC output filter 15 and supplied to the load 14.

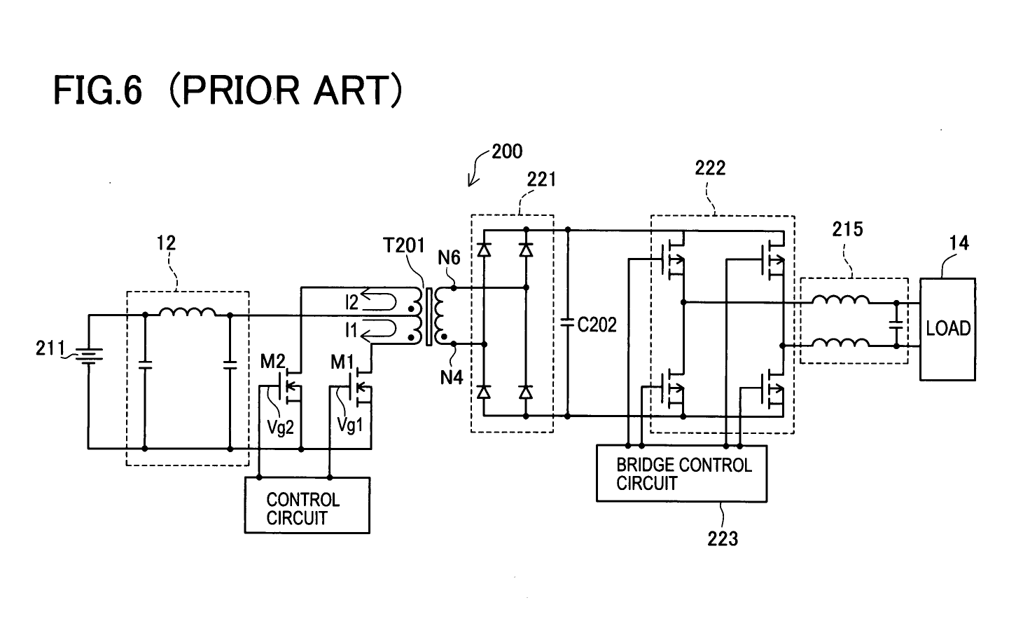

Reference is made to the circuit diagram of FIG. 6 to explain the configuration of a conventional DC/AC converter 200 for comparison purpose. Since the configuration of the primary side of the transformer T201 in the DC/AC converter 200 is the same as of the DC/AC converter 10 shown in FIG. 1, an explanation for it is skipped herein. In the secondary side, a rectifying circuit 221; a smoothing capacitor C202; a bridge circuit 222; an AC output filter 215; and a bridge control circuit 223 are provided. The rectifying circuit 221 converts a high AC output voltage generated in the secondary winding of the transformer T201 into a DC voltage which is, in turn, smoothed by the smoothing capacitor C202 to be outputted to the bridge circuit 222. The bridge circuit 222 has four transistors connected in H-bridge form. The diagonally opposed pairs of transistors are alternately turned ON with a specified duty so that an AC voltage having the second frequency f2 (55 Hz) is generated at the AC output filter 215 and outputted to the load 14.

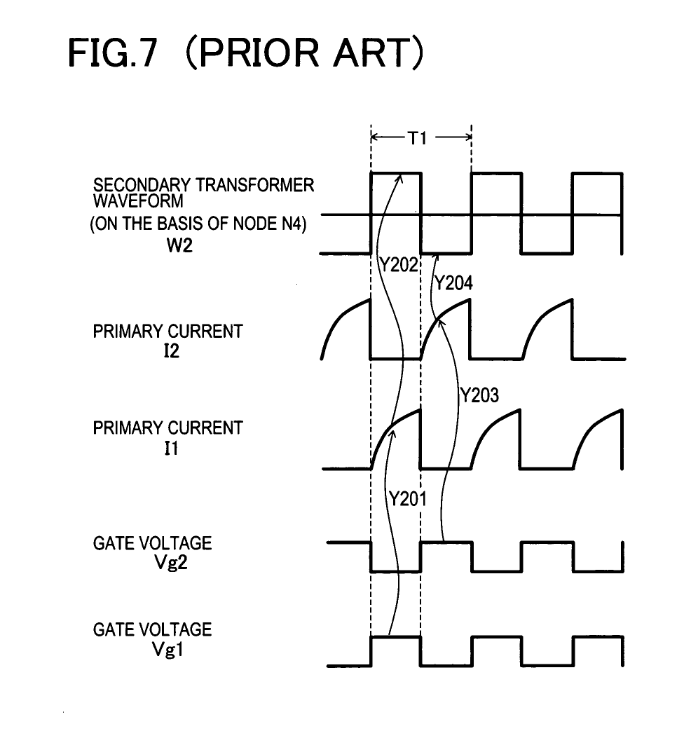

The operation of the conventional DC/AC converter 200 will be described with reference to the timing chart of FIG. 7. As shown in FIG. 7, the gate voltages Vg1 and Vg2 are alternately switched between high level/low level at the first frequency f1 (cycle T1= 1/100 k (sec)). While the gate voltage Vg 1 is at a high level, the transistor M1 becomes conductive so that the primary current I1 flows (arrow Y201). The primary current I1 is insulation-transferred through the transformer TR201. Then, a transformer waveform W2 that represents the voltage (the node N4 to node N6 voltage) generated in the secondary winding comes to have plus polarity (on the basis of the node N4) (arrow Y202).

On the other hand, when the gate voltage Vg2 is at a high level, the transistor M2 becomes conductive so that the primary current 12 flows (arrow Y203). The primary current 12 is insulation-transferred through the transformer TR201 so that a secondary transformer waveform W2 comes to have minus polarity (on the basis of the node N4) (arrow Y204). Specifically, a DC power supply 211 (DC 12V) is converted into a high-frequency AC power supply having the first frequency f1 by switching the transistors M1 and M2 and this AC power supply is insulation-transferred, so that an AC voltage having the secondary transformer waveform W2 is generated in the secondary winding.

The AC voltage having the secondary transformer waveform W2 is rectified by the rectifying circuit 221, thereby generating a high DC voltage (140 V). By use of the bridge circuit 222 and the bridge control circuit 223, this DC voltage is converted into a commercial AC voltage of the second frequency f2 (55 Hz) which is, in turn, supplied to the load 14 through the AC output filter 215.

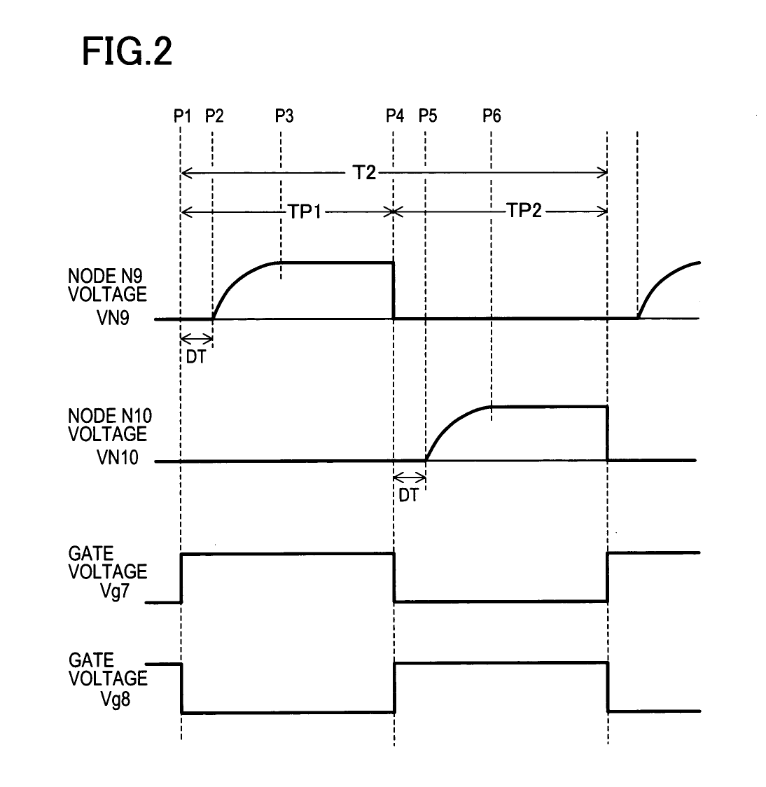

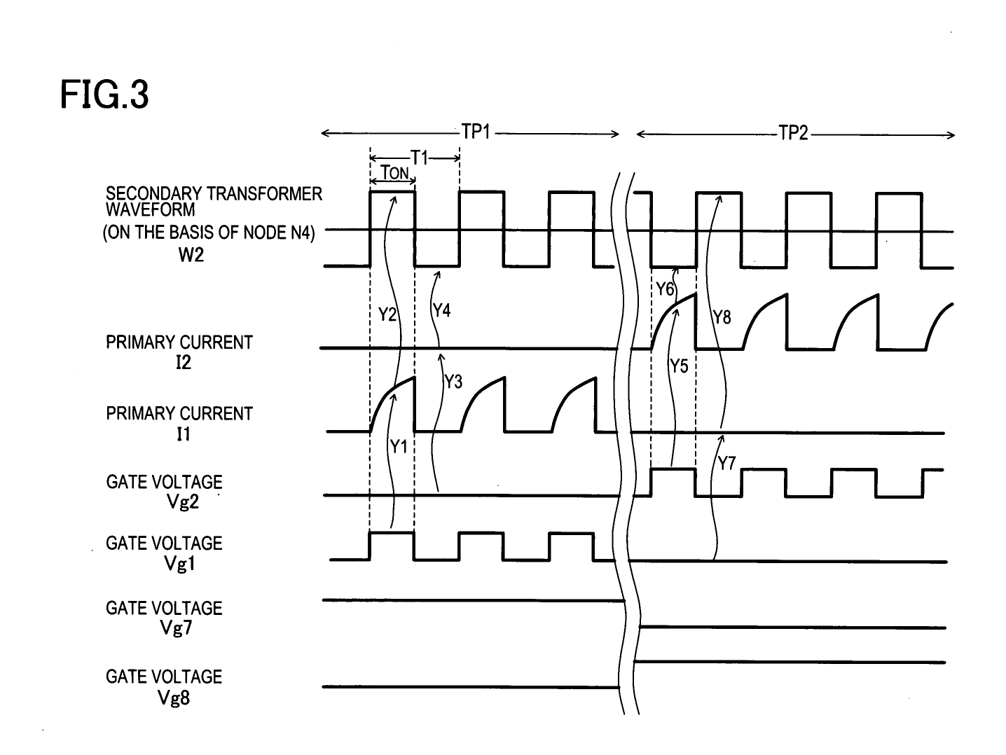

Next, the operation of the DC/AC converter 10 of the invention will be described with reference to the timing charts of FIGS. 2, 3. As shown in FIG. 2, the gate voltages Vg7, Vg8 of the secondary transistors M7, M8 alternate between high level/low level at the second frequency f2 (55 Hz) (cycle T2 (= 1/55 (sec)). Herein, the period during which the transistor M7 is in its conductive state is defined as “period TP1” and the period during which the transistor M8 is in its conductive state is defined as “period TP2”.

First, the operation performed in the period TP1 will be explained. At a time P1, the gate voltage Vg7 goes to a high level and the transistor M7 becomes conductive, whereas the gate voltage Vg8 goes to a low level and the transistor M8 becomes non-conductive. Therefore, in FIG. 1, a current path directed to the node N6, the body diode D8, the smoothing capacitor C2, the transistor M7 and the node N4 is formed in the secondary side of the transformer TR1. With this current path, only a voltage of plus polarity (on the basis of the node N4) is selected from the AC voltages generated in the secondary winding of the transformer TR1 and outputted to the AC output filter 15 during the time period TP1.

At a time P2 after an elapse of a dead time DT, the switching circuit 13 initiates operation. The dead time DT is a specified period of time set for preventing the transistors M1, M2 of the switching circuit 13 from becoming conductive at the same time.

Reference is made to the timing chart of FIG. 3 to explain the operation of the switching circuit 13. FIG. 3 is an enlarged view of the time axis shown in FIG. 2. As shown in FIG. 3, in the time period TP1, only the gate voltage Vg1 is switched to a high or low level at the first frequency f1 (100 kHz), while the gate voltage Vg2 being maintained at a low level.

In the period during which the gate voltage Vg1 is at a high level, the transistor M1 becomes conductive and the primary current I1 (FIG. 1) flows (arrow Yl). The primary current I1 is insulation-transferred through the transformer TR1. In the secondary winding, a voltage of plus polarity (on the basis of the node N4) is generated (arrow Y2).

At that time, a current path is formed such that only the voltage of plus polarity is selected from the AC voltages generated in the secondary winding of the transformer TR1 and outputted to the AC output filter 15 in the time period TP1 as described earlier. Therefore, an electric current flows into a path in the secondary side so that the smoothing capacitor C2 is charged.

In the period during which the gate voltage Vg1 is at a low level, the transistor M1 becomes non-conductive so that the primary current I1 does not flow. The gate voltage Vg2 is also at a low level and therefore the transistor M2 is in its non-conductive state, so that the primary current 12 does not flow (arrow Y3). In the secondary winding, a voltage of minus polarity (on the basis of the node N4) is generated (arrow Y4). At that time, there is formed a path for outputting only the voltage of plus polarity selected from the voltages generated in the secondary winding of the transformer TR1 as described earlier. Therefore, no electric current flows to the path in the secondary side so that the smoothing capacitor C2 is not charged. This operation is repeated, thereby increasing a node N9 voltage VN9 (FIG. 2) that corresponds to the plus polarity (on the basis of the node N4) of the secondary winding.

Next, the operation performed in the time period TP2 (FIG. 2) will be explained. In the time period P4, the gate voltage Vg7 goes to a low level and the transistor M7 is brought into its non-conductive state, whereas the gate voltage Vg8 goes to a high level and the transistor M8 is brought into its conductive state. Therefore, a current path is formed in the secondary side of the transformer TR1 (see FIG. 1), the current path being directed to the node N4, the body diode D7, the smoothing capacitor C2, the transistor M8 and the node N6. With this current path, only a voltage of minus polarity (on the basis of the node N4) is selected from the AC voltages generated in the secondary winding of the transformer TR1 and outputted to the AC output filter during the time period TP2. At a time P5 after an elapse of the dead time DT, the switching circuit 13 initiates operation.

The operation of the switching circuit 13 will be described referring to the timing chart of FIG. 3. As shown in FIG. 3, in the time period TP2, only the gate voltage Vg2 is switched to a high or low level at the first frequency f1 (100 kHz), while the gate voltage Vg1 being maintained at a low level. In the period during which the gate voltage Vg2 is at a high level, the transistor M2 becomes conductive so that the primary current I2 flows (arrow Y5). The primary current 12 is insulation—transferred through the transformer TR1. In the secondary winding, a voltage of minus polarity (on the basis of the node N4) is generated (arrow Y6). Since the path for outputting only the voltage of minus polarity selected from the voltages generated in the secondary winding of the transformer TR1 is formed as noted above, an electric current flows into the path in the secondary side so that the smoothing capacitor C2 is charged.

In the period during which the gate voltage Vg2 is at a low level, the transistor M2 becomes non-conductive so that the primary current I2 does not flow. The gate voltage Vg1 is also at a low level and therefore the transistor M1 is in its non-conductive state, so that the primary current I1 does not flow (arrow Y7). In the secondary winding, a voltage of plus polarity (on the basis of the node N4) is generated (arrow Y8). Therefore, an electric current does not flow into the path in the secondary side so that the smoothing capacitor C2 is not charged. This operation is repeated, thereby increasing a node N10 voltage VN10 (FIG. 2) that corresponds to the minus polarity (on the basis of the node N4) of the secondary winding. Thus, the operations performed in the time periods TPI, TP2 are repeated at the second frequency f2 (55 Hz) whereby an AC voltage having the second frequency f2 can be obtained.

There will be explained the advantage of the switching control in which only the transistor M1 is switched in the time period TP1 and only the transistor M2 is switched in the time period TP2. In the time period TP1, the transistor M7 is in its conductive state whereas the transistor M8 is in its non-conductive state, so that a current path for flowing an electric current in the rectifying direction of the body diode D8 is established in the secondary side of the transformer. Therefore, even if the transistor M2, which is a switch for allowing a flow of electric current in the rectifying direction of the body diode D7, is switched, the flow of electric current is interrupted by the body diode D8 so that no power is transferred to the secondary side. Therefore, the switching operation of the transistor M2 in the time period TP1 becomes useless and the actual power outputted to the load 14 does not vary irrespective of whether, or not the transistor M2 is switched.

In the time period TP2, the transistor M8 is in its conductive state whereas the transistor M7 is in its non-conductive state, so that a current path for flowing an electric current in the rectifying direction of the body diode D7 is established in the secondary side of the transformer. Therefore, even if the transistor M1 for allowing a flow of electric current in the rectifying direction of the body diode D8 is switched, the flow of electric current is interrupted by the body diode D7 so that no power is transferred to the secondary side. Therefore, the switching operation of the transistor M1 in the time period TP2 becomes useless and the actual power outputted to the load 14 does not vary irrespective of whether or not the transistor M1 is switched.

Thus, only the transistor M1 is selectively switched in the time period TP1 and only the transistor M2 is selectively switched in the time period TP2, whereby the useless switching operations of the transistors M1, M2 can be obviated without causing a drop in the output of power transferred to the load 14.

Next, the soft start control for switching of the transistors M1, M2 will be explained. Referring to FIG. 2, the so-called soft start control is performed, in which the node N9 voltage VN9 in the period from the time P2 to the time P3 and the node N10 voltage VN10 in the time period from the time P5 to the time P6 gradually increase after an elapse of the dead time DT.

In the period TP1, the soft start control starts at a starting point (the time P2) after an elapse of the dead time DT since the time P1 at which switching of the transistors M7, M8 is done. Then, the duty, i.e., on-time Ton (FIG. 3) of the transistor M1 increases with time. After an elapse of a specified period of time (time P3), the duty reaches a value for the steady state which value provides a rated output for the load 14. Since the soft start control performed during the time period TP2 is the same as that of the time period TP1, an explanation of it is skipped herein. Accordingly, the soft start is performed whenever the transistors M7, M8 are switched at the second frequency f2.

Since the current flowing direction of the current path formed in the secondary side of the transformer TR1 is reversed at the second frequency f2, there is a likelihood that a rush current occurs at the time of the reversal. However, occurrence of overcurrent in the current path can be prevented by performing the soft start control. As a result, damage to the devices and overheating can be prevented.

As the value of the duty that provides the rated output, an estimated specified value may be used. Alternatively, the optimum duty may be calculated for each case based on a voltage value (feedback value) detected by the AC output filter 15.

As heretofore described in detail, the DC/AC converter 10 of the first embodiment is configured such that when a current path for flowing an electric current in the forward direction of the body diode D8 is formed in the secondary side of the transformer TR1, a voltage component having plus polarity (on the basis of the node N4) is selected from AC voltages generated in the secondary winding of the transformer TR1 by this current path. Similarly, when a current path for flowing an electric current in the forward direction of the body diode D7 is formed in the secondary side of the transformer TR1, a voltage component having minus polarity (on the basis of the node N4) is selected from the AC voltages generated in the secondary winding of the transformer TR1 by this current path. Plus and minus polarities are alternately selected at the second frequency f2 (55 Hz), thereby enabling it to supply an AC voltage of the second frequency f2 to the load 14 through the AC output filter 15.

With the above arrangement, DC/AC conversion using a transformer can be done only by one converting operation from a DC voltage to an AC voltage. Thus, the number of converting operations can be reduced and, in consequence, the circuit can be simplified compared to, for instance, the DC/AC converter 200 (FIG. 6) in which three converting steps (DC→AC→DC→AC) are required for conversion from a DC voltage to an AC voltage. This leads to advantages such as scale-down of the circuit, cost reduction due to the reduced number of parts, and an increase in the reliability of the DC/AC circuit 10.

In the DC/AC converter 10 of the first embodiment, if the rectifying direction of the body diode D7 is selected, only the transistor M2 for generating an electric current in this direction is selectively switched thereby obviating the useless operation of switching the transistor M1 while ensuring generation of an output voltage. Similarly, if the rectifying direction of the body diode D8 is selected, only the transistor M1 for generating an electric current in this direction is selectively switched thereby obviating the useless operation of switching the transistor M2 while ensuring generation of an output voltage. As a result, the excessive consumption of driving power by the transistors M1, M2 can be avoided.

In addition, there is no need to alternately switch the transistors M1, M2 at the first frequency f1 that is high frequency, while taking account of the dead time. This eliminates the need for complicated control of the transistors M1, M2, so that the control circuit 16 can be simplified.

In the DC/AC converter 10 of the first embodiment, the body diodes D7, D8, which are provided for the NMOS transistors M7, M8 respectively, are used as a rectifying device. This eliminates the need to use an external rectifying device and therefore simplifies the circuit configuration. As a result, the circuit scale can be reduced and cost reduction due to a reduction in the number of parts can be achieved.

In the DC/AC converter 10 of the first embodiment, the switching circuit 13 outputs an AC voltage of the first frequency f1 (100 kHz) that is higher than the second frequency f2 (55 Hz) and the transformer TR1 transfers it. In contrast with the case where power is transferred at the second frequency f2, there is no need to enlarge the core of the transformer TR1 nor increase the size of the circuit.

According to the DC/AC converter 10 of the first embodiment, the state where the transistor M7 is conductive whereas the transistor M8 is non-conductive and the state where the transistor M7 is non-conductive whereas the transistor M8 is conductive are alternately changed at the second frequency f2. Whenever the switch-over between these states is done, soft start for switching of the transistors M2, M1 is performed. This prevents occurrence of overcurrent in the current path formed in the secondary side of the transformer TR1 and, in consequence, enables it to avoid damage to the devices and overheating.

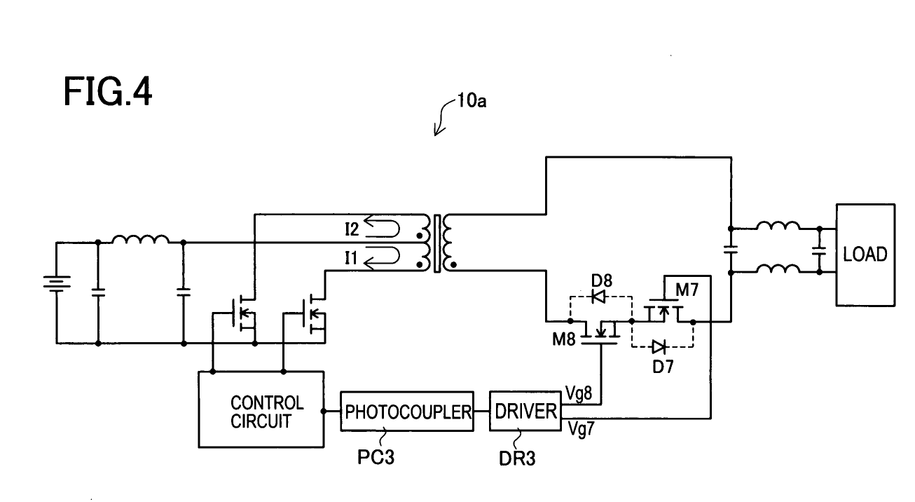

Reference is made to FIG. 4 to describe a second embodiment. FIG. 4 shows a circuit diagram of a DC/AC converter 10a constructed according to the second embodiment. The source terminals of the transistors M7 and M8 are connected to a common connection. The DC/AC converter 10a has a photocoupler PC3 and a driver DR3 in place of the photocouplers PC1, PC2 and the drivers DR1, DR2 which are provided for the DC/AC converter 10 (FIG. 1). Except the above points, the DC/AC converter 10a does not differ from the DC/AC converter 10 in configuration and therefore a further explanation is skipped herein.

Since the source terminals of the transistors M7, M8 shown in FIG. 1 are not connected to a common connection, reference potentials for the gate voltages Vg7, Vg8 differ from each other. Therefore, the drivers DR1, DR2 that correspond to the different gate voltages Vg7, Vg8 respectively are required. Also, the photocouplers PC1, PC2 are necessary for insulation-transfer of a control signal from the control circuit 16.

On the other hand, the sources of the transistors M7, M8 shown in FIG. 4 are connected to a common connection, so that the gate voltages Vg7, Vg8 have a common reference potential. Therefore, the common driver DR3 can be shared when providing the gate voltages Vg7, Vg8.

As heretofore described in detail, the DC/AC converter 10a of the second embodiment is configured such that the source terminals of the transistors M7, M8 are connected to a common connection so that a common driver circuit can be used for application of gate voltages. This contributes to simplification of the driver circuit for gate voltage application and therefore to a reduction in the number of parts. As a result, the circuit can be scaled down and cost reduction due to the reduction in the number of parts and increased reliability etc. can be achieved.

It is obvious that the invention is not necessarily limited to the particular embodiments shown herein and various changes and modifications may be made to the disclosed embodiments without departing from the spirit and scope of the invention. In the first embodiment, the soft start for switching of the transistors M1, M2 is performed whenever the transistors M7, M8 are switched at the second frequency f2 as shown in FIG. 2. By optimizing the soft start control at that time, the waveforms of the node N9 voltage VN9 and the node N10 voltage VN10 can be made close to a sinusoidal waveform.

More concretely, control is performed for making the soft start period shown in FIG. 2 (the period from the time P2 to the time P3; the period from the time P5 to the time P6) close to a cycle that is one fourth the cycle T2. The duty of the transistors M1, M2 are sequentially calculated from feedback values detected by the AC output filter 15, whereby control for making the rising waveform of the soft start be a sinusoidal waveform is performed. Thus, the waveform of the AC voltage to be supplied to the load 14 can be made to be a pseudo sinusoidal waveform (i.e., a waveform which is sinusoidal in a half period). Since use of such a pseudo sinusoidal waveform extends the range of systems usable as the load 14, the DC/AC converter 10 can be used in a wide range of applications.

Although the forgoing embodiments have been particularly discussed in the context of the arrangement in which the body diodes D7, D8 of the transistors M7, M8 serve as a rectifying element, the invention is not necessarily limited to such embodiments. Apparently, the invention is equally applicable to an arrangement in which another diode element is placed in parallel with the transistors M7, M8, being connected in the same direction as of the body diodes D7, D8. It is also apparent that, in this case, the transistors M7, M8 are not limited to MOS transistors but may be bipolar transistors or IGBT.

Although the forgoing embodiments have been particularly discussed in the context of the arrangement in which only the transistor M1 is switched in the period TP1 and only the transistor M2 is switched in the period TP2, the invention is not limited to such embodiments. The transistors M1, M2 may be switched at the first frequency f1 (100 kHz) while keeping the opposite-phase relationship in which either of them is ON while the other being OFF. In this case, DC/AC conversion by use of a transformer can be also done by effecting one converting operation from a DC voltage to an AC voltage.

Although the foregoing embodiments have been particularly discussed with the transformer TR1 that is a forward transformer in which the primary winding and the second winding have the same winding direction, TR1 is apparently not limited to such a transformer but may be a flyback transformer with the primary and secondary windings wound in different directions. In addition, while signal insulation is assured by photocouplers in the foregoing embodiments, other techniques such as pulse transformers may be employed.

It should be noted that the body diode D7 is one form of the first rectifying device; the body diode D8 is one form of the second rectifying device; the transistors M7, M8 are one form of the bypass switches; the transistor M2 is one form of the first switch; and the transistor M1 is one form of the second switch.

According to the invention, there is provided a DC/AC converter and a DC/AC conversion method which realize a simple circuit configuration by employing easy converting operation; save the amount of driving power consumed by the switching operation while ensuring generation of output power; and enable use of a small-sized transformer, in conversion from a DC voltage to an AC voltage by use of a transformer.

In the DC/AC converter, preferably,

the first and second bypass switches are MOS transistors respectively, and

at least part of the first and second rectifying devices is the body diode of the MOS transistor.

The MOS transistors each have a body diode. As at least part of the first and second rectifying devices, the body diodes are used. Where another rectifying device is connected in parallel with the MOS transistors so as to have the same direction as that of the body diodes of the MOS transistors for instance, the first and second rectifying devices partially function the body diodes.

Where rectification is done only by the body diodes without use of another rectifying device, the first and second rectifying devices entirely function as the body diodes. In this case, there is no need to provide another external rectifying device, so that the circuit can be simplified, leading to a reduction in the scale of the circuit and cost reduction due to a reduced number of parts.

In the DC/AC converter, preferably, the source terminals of the MOS transistors are connected to a common connection.

The source terminals of the MOS transistors, each of which serves as a bypass switch, are connected to a common connection so that the reference potential for gate potential is common to the first and second bypass switches. Thereby, the power supply circuit for supplying a gate voltage can be shared by the MOS transistors, which obviates the need for use of a plurality of power supply circuits. This makes it possible to reduce the number of parts provided for the gate voltage supply circuit so that the circuit can be scaled down and cost reduction due to the reduction in the number of parts can be achieved.

In the DC/AC converter, preferably,

the switching circuit comprises a first switch for allowing a flow of electric current to the first rectifying device through the transformer and a second switch for allowing a flow of electric current to the second rectifying device through the transformer, and

the first switch and/or second switch are switched at the first frequency.

The switching circuit has the first and second switches. The first switch allows an electric current to flow to the first rectifying device through the transformer. The second switch allows an electric current to flow to the second rectifying device through the transformer. The first switch and/or second switch are switched at the first frequency.

For instance, the first and second switches may be switched at the first frequency while keeping the opposite phase relationship in which either one of the first and second switches is ON whereas the other is OFF. An alternative arrangement is such that either the first or second switch is selected and only the selected switch is switched at the first frequency.

In the DC/AC converter, preferably,

only the first switch is switched at the first frequency in a period during which the second bypass switch for the second rectifying device is in its conductive state, and

only the second switch is switched at the first frequency in a period during which the first bypass switch for the first rectifying device is in its conductive state.

In the period during which the second bypass switch for the second rectifying device is conductive whereas the first bypass switch for the first rectifying device is non-conductive, a current path for flowing an electric current in the rectifying direction of the first rectifying device is formed in the secondary side of the transformer. In this period, only the first switch that allows a flow of electric current to the first rectifying device is switched at the first frequency.

Owing to the formation of the current path for flowing an electric current in the rectifying direction of the first rectifying device, a voltage component having a polarity that generates a flow of electric current in the rectifying direction of the first rectifying device is selected from AC voltages generated in the secondary winding of the transformer. At that time, even if the second switch that allows a flow of electric current in the rectifying direction of the second rectifying device is switched, an electric current is not generated in the secondary side because the second rectifying device has a polarity opposite to that of the first rectifying device. Thus, electric power cannot be transferred to the secondary side by switching the second switch and this switching action therefore becomes useless.

In view of this, in the period during which the current path for flowing an electric current in the rectifying direction of the first rectifying device is formed, only the first switch that allows a flow of electric current in this direction is selectively switched, whereby the useless switching operation of the second switch is eliminated while ensuring generation of an output voltage.

Similarly, in the period during which the current path for flowing an electric current in the rectifying direction of the second rectifying device is formed, electric power cannot be transferred to the secondary side by switching the first switch that allows a flow of electric current in the rectifying direction of the first rectifying device. Therefore, the switching operation of the first switch is useless. In view of this, in this period, only the second switch is selectively switched, whereby the useless switching operation of the first switch is eliminated while ensuring generation of an output voltage. This makes it possible to restrict the wasteful driving power consumption of the switches.

In the DC/AC converter, preferably,

whenever the first and second bypass switches are switched, soft start is performed for switching of the first switch and/or the second switch.

The first and second bypass switches are switched in such a way that the state where the first bypass switch is conductive whereas the second bypass switch is non-conductive and the state where the first bypass switch is non-conductive whereas the second bypass switch is conductive are alternately changed at the second frequency. Each time the switch-over between these states is done, soft start for the first switch and/or the second switch is performed.

Since the current flowing direction of the current path formed in the secondary side of the transformer is reversed at the second frequency, there is a possibility of occurrence of a rush current at the time of reversing the current flowing direction. To prevent occurrence of overcurrent in the current path, soft start is performed whenever the current flowing direction is reversed, and as a result, damage to the devices and overheating can be avoided.

The soft start control starts after an elapse of a specified dead time after switching from one bypass switch to the other is done. In this control, the duty of the first and/or second switch gradually increases from a value which is sufficiently smaller than the duty for the stationary state that provides a rated output. After an elapse of a specified period of time, the duty reaches the value for the stationary state that provides a rated output.

In the DC/AC conversion method, preferably,

the step of converting into the AC voltage having the second frequency is such that first and second polarities of the AC voltage having the first frequency appearing in the secondary winding are alternately rectified and outputted at the second frequency.

The first and second polarities of the AC voltage having the first frequency that appears on the secondary winding are alternately rectified to be outputted at the second frequency. The polarity of the voltage outputted from the secondary side of the transformer is changed at the second frequency. This enables direct conversion from the AC voltage having the first frequency to the AC voltage having the second frequency.

In the DC/AC conversion method, preferably,

the step of converting a DC voltage into an AC voltage includes:

a first supply step of feeding electric power corresponding to the first polarity through the transformer; and

a second supply step of feeding electric power corresponding to the second polarity through the transformer, and

only the first supply step is performed in a period during which the first polarity is rectified and only the second supply step is performed in a period during which the second polarity is rectified.

Even if the step of feeding the power corresponding to the second polarity through the transformer is done in the period during which the first polarity is rectified, the power cannot be transferred to the secondary side because of opposite polarity and therefore the second supplying step is useless. Therefore, only the step of feeding the power corresponding to the first polarity is selectively done in the period during which the first polarity is rectified, whereby the useless supplying action can be avoided while continuing generation of an output voltage.

Similarly, in the period during which the second polarity is rectified, the step of feeding the power corresponding to the second polarity through the transformer is selectively done, whereby the useless supplying action can be avoided ‘while continuing generation of an output voltage. In this way, the useless power supplying steps are obviated, so that the amount of power required for the DC/AC conversion can be reduced.

What is claimed:

1. A DC/AC converter comprising:
a switching circuit for converting a DC voltage into an AC voltage having a first frequency;
a transformer for insulation-transferring the AC voltage:
a first rectifying device incorporated into a path that connects terminals of a secondary winding of the transformer;
a second rectifying device incorporated into the path that connects the terminals of the secondary winding of the transformer, so as to have a direction opposite to the direction of the first rectifying device; and
first and second bypass switches for bypassing the first and second rectifying devices respectively,
wherein a state where the first bypass switch is in its conductive state whereas the second bypass switch is in its non-conductive state and a state where the first bypass switch is in its non-conductive state whereas the second bypass switch is in its conductive state are alternately changed at a second frequency that is lower than the first frequency.

2. The DC/AC converter according to claim 1,
wherein the first and second bypass switches are MOS transistors respectively, and
wherein at least part of the first and second rectifying devices is the body diode of the MOS transistor.

3. The DC/AC converter according to claim 2, wherein the source terminals of the MOS transistors are connected to a common connection.

4. The DC/AC converter according to claim 1,
wherein the switching circuit comprises a first switch for allowing a flow of electric current to the first rectifying device through the transformer and a second switch for allowing a flow of electric current to the second rectifying device through the transformer, and
wherein the first switch and/or second switch are switched at the first frequency.

5. The DC/AC converter according to claim 4,
wherein only the first switch is switched at the first frequency in a period during which the second bypass switch for the second rectifying device is in its conductive state, and
wherein only the second switch is switched at the first frequency in a period during which the first bypass switch for the first rectifying device is in its conductive state.

6. The DC/AC converter according to claim 4,
wherein whenever the first and second bypass switches are switched, soft start is performed for switching of the first switch and/or the second switch.

7. A DC/AC conversion method comprising the steps of:
converting a DC voltage into an AC voltage having a first frequency;
transferring the AC voltage having the first frequency to a secondary side through a transformer; and
converting the AC voltage having the first frequency that appears in a secondary winding of the transformer into an AC voltage having a second frequency that is lower than the first frequency.

8. The DC/AC conversion method according to claim 7,
wherein the step of converting into the AC voltage having the second frequency is such that first and second polarities of the AC voltage having the first frequency appearing in the secondary winding are alternately rectified and outputted at the second frequency.

9. The DC/AC conversion method according to claim 8,
wherein the step of converting a DC voltage into an AC voltage includes the steps of:
feeding electric power corresponding to the first polarity through the transformer; and
feeding electric power corresponding to the second polarity through the transformer, and
wherein only the step of feeding electric power corresponding to the first polarity is performed in a period during which the first polarity is rectified and only the step of feeding electric power corresponding to the second polarity is performed in a period during which the second polarity is rectified.
